(19) United States
(12) Patent Application Publication
(10) Pub. No.: US 2008/0206526 A1
(43) Pub. Date: Aug. 28, 2008

(54) PROTECTIVE MATERIAL HAVING GUARD PLATES ON CLEARLY VISIBLE SUBSTRATE

(75) Inventors: Steven KIM, Woodbury, MN (US); Clifton F. Richardson, Woodbury, MN (US); Young Kwon Kim, Woodbury, MN (US); Sangkyung Lee, Woodbury, MN (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: Higher Dimension Materials, Inc., Oakdale, MN (US)

(21) Appl. No.: 12/036,813

(22) Filed: Feb. 25, 2008

Related U.S. Application Data
(60) Provisional application No. 60/891,317, filed on Feb. 23, 2007.

(51) Int. Cl. B32B 33/00

(52) U.S. Cl. 428/195.1

(57) ABSTRACT

A supple, globally flexible, composite protective material having guard plates on a substrate with a clearly visible pattern. The substrate is flexible and has a surface with a colored pattern including two or more colors. The guard plates are small, non-overlapping, printed resin material members having major and minor dimensions and are arranged in a predetermined pattern over a substantial portion of the surface of the substrate. In one embodiment of the invention the guard plates are transparent or translucent to visible light so that the colored pattern on the surface of the substrate is visible. In another embodiment the colors of the guard plates blend in with the colored pattern of the substrate.

### REFERENCE TO RELATED APPLICATION

This application claims the benefit of U.S. Provisional Application Ser. No. 60/891,317, filed Feb. 23, 2007 and entitled PENETRATION, SLASH AND/OR ABRASION RESISTANT MATERIAL HAVING GUARD PLATES AND CLEARLY VISIBLE SUBSTRATE, which is incorporated herein by reference.

### TECHNICAL FIELD

The present invention relates generally to protective materials. More specifically, the invention is a protective material including printed guard plates on a flexible substrate.

### BACKGROUND

Various forms of protective materials have been advanced and used to form protective garments such as gloves, jackets and the like. In addition to providing protective functions such as cut and puncture resistance, the fabric material may also be flexible, durable, and abrasion resistant, and facilitate, improve, or allow the gripping and holding of objects.

Many forms of protective garments have utilized fabrics made from woven or non-woven forms of fibers and yarns. Some commonly used fibers include cellulose (cotton), polyester, nylon, aramid (Kevlar), acrylic and Ultra-High Molecular Weight Polyethylene (Spectra). Nevertheless, it is often difficult to achieve all the desired performance characteristics in a protective material for a specific application when only fibers are used to form the protective material. For example, an aramid fabric has high tensile strength and is ballistic resistant, but the fabric is nevertheless weak against abrasion, degrades upon exposure to sunlight, and offers little puncture resistance against sharp, needle-like objects. As another example, fabrics made of nylon are strong and have good abrasion resistance, but the nylon fabric has low cut resistance against sharp edges and poor thermal and chemical (particularly acid) stability. In general, compromises usually have to be made when using a pure fabric, especially in high-performance fabric applications.

A protective material design that integrates a flexible substrate with rigid guard plates has been advanced by HDM, Inc. of St. Paul, Minn. and distributed under the trademark SuperFabric®. Generally, this material includes a plurality of guard plates, which are thin and formed of a substance chosen to resist a penetration or cutting force equivalent to or stronger than that for which the material is to be used and designed. In one embodiment, a polymer resin is used as the material forming the guard plates. The resin can be printed on the flexible substrate in a design that forms spaced-apart guard plates. The resin affixes to the flexible substrate and when cured, forms a strong bond therewith. The composite nature of the material assembly makes it possible to realize locally (in an area comprising one or a few guard plates) hard, puncture and cut resistant plate features. However, at the same time, the overall material assembly exhibits global conformability due to the flexibility of the substrate and the spaced apart relationship of the guard plates.

Many protective fabrics such as aramid (Kevlar), acrylic and Ultra-High Molecular Weight Polyethylene (Spectra) depend highly on a tight weave construction in order to achieve their desired protective performance. In addition, multiple layers must often be utilized due to the fact that one individual layer of these fabrics is usually weak against cut (shear), abrasion, and puncture from sharp, needle-like objects, despite their high tensile strength. A significant drawback of having a single or multiple layers of a tightly-woven fabric is its low air permeability, which often causes discomfort to the user since perspiration cannot escape via evaporation. SuperFabric® however has a significant advantage in air breathability due to its array of guard plates printed onto the substrate, and the open gap spaces in-between the guard plates. Because these guard plates are hard and cut/puncture/abrasion resistant, fabric with a substantially looser weave can be utilized as a substrate, thus significantly increasing air permeability. Furthermore, in many cases only one or a few layers of SuperFabric® are necessary to achieve the desired protective level, rather than many layers of the other fabrics, due to the hardness or toughness and mechanical strength of these guard plates, thereby giving SuperFabric® an advantage in air breathability and user comfort.

The air permeability advantages of SuperFabric® can be compared to commercially-available flame retardant fabrics. Many commercially-available fabrics depend on a continuous layer coating of flame retardant material in order to achieve their flame performance specifications. However, a flame retardant version of SuperFabric® includes a highly effective flame retardant agent as an additive to the guard plates only. The guard plates are thereby used as carrier vehicles of the flame retardant agent, rather than a continuous coating layer of flame retardant material on the entire fabric. Because of this, the open gap spaces in the flame retardant SuperFabric® remain free of any coating and unobstructed, with the fabric substrate directly exposed to air, and therefore the air permeability advantage of flame retardant SuperFabric® is maintained.

For some applications of SuperFabric® brand material, the guard plates are particularly hard and thereby resist puncture, fracture, or cutting, and resist separation from the flexible substrate. The characteristics that provide these features may not be entirely suitable for all applications. For instance, some applications may require a higher degree of wear resistance, while others require a tactile surface that improves grip. To address this, HDM, Inc. manufactures and sells a variety of different versions of SuperFabric®. Each version is designed to possess specialized features and strengths to provide optimum performance to their respective applications. HDM, Inc. also custom-engineers resin formulations to match the unique protective requirements of each individual customer. There is, therefore, a continuing need for protective fabrics having features suitable for a variety of applications.

### SUMMARY

The invention is a supple, globally flexible, composite protective material having guard plates on a substrate with a clearly visible pattern. The substrate is flexible and has a surface with a colored pattern including two or more colors. The guard plates are small, non-overlapping, printed resin material members having major and minor dimensions and are arranged in a predetermined pattern over a substantial portion of the surface of the substrate. In one embodiment of the invention the guard plates are transparent or translucent to visible light so that the colored pattern on the surface of the substrate is visible. In another embodiment the colors of the guard plates blend in with the colored pattern on the substrate.

### BRIEF DESCRIPTION OF THE DRAWINGS

FIGS. 1A-1C show various views of a protective material having a flexible substrate and spaced-apart hexagonal plates according to one embodiment of the present invention.

FIG. 2 shows a top plan view of a protective material having a flexible substrate and spaced-apart hexagonal plates according to another embodiment of the present invention.

FIG. 3 shows a top plan view of a protective material having a flexible substrate and spaced-apart pentagon and square plates according to another embodiment of the present invention.

FIG. 4 shows a top plan view of a protective material having a flexible substrate and spaced-apart pentagon and square plates according to yet another embodiment of the present invention.

FIG. 5 shows a top plan view of a protective material having a flexible substrate and spaced-apart circular plates according to another embodiment of the present invention.

FIG. 6 shows a top plan view of a protective material having a flexible substrate and spaced-apart circular plates according to yet another embodiment of the present invention.

FIG. 7 shows a top plan view of a protective material having a flexible camouflage colored substrate and spaced-apart transparent circular plates according to yet another embodiment of the present invention.

FIG. 8 shows a top plan view of a protective material having a flexible camouflage colored substrate and spaced-apart circular plates with color chosen to blend in with the colored substrate according to yet another embodiment of the present invention.

FIG. 9 shows a top plan view of a protective material having a flexible camouflage colored substrate and circular plates with color chosen to blend in with the colored substrate that have close spacing between adjacent plates according to yet another embodiment of the present invention.

FIG. 10 shows a graph of abrasion resistance as a function of area fraction covered by guard plates.

FIG. 11 shows a graph of abrasion resistance as a function of guard plate diameter and gap between guard plates.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

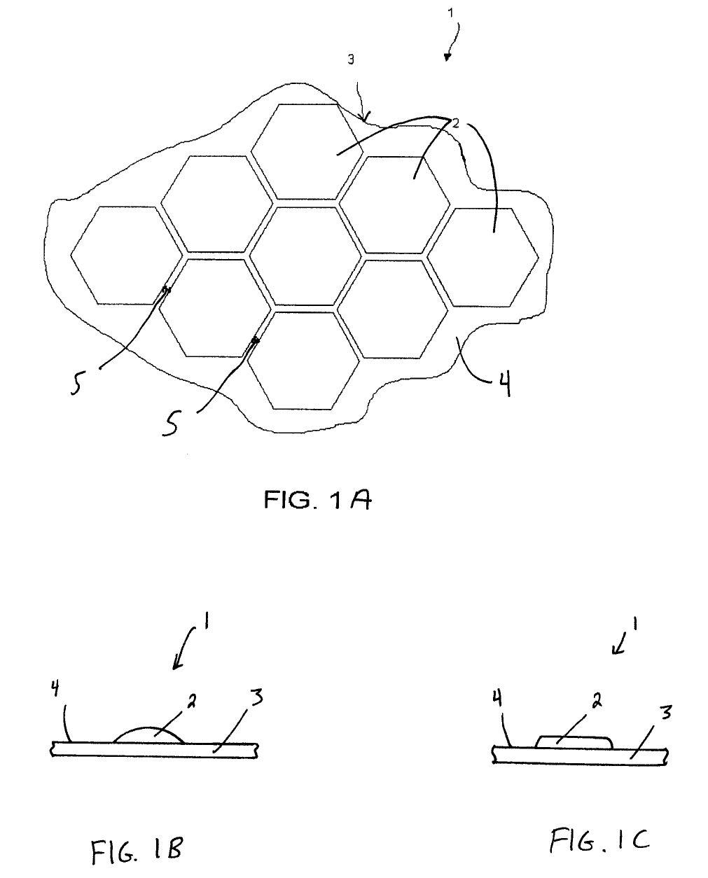

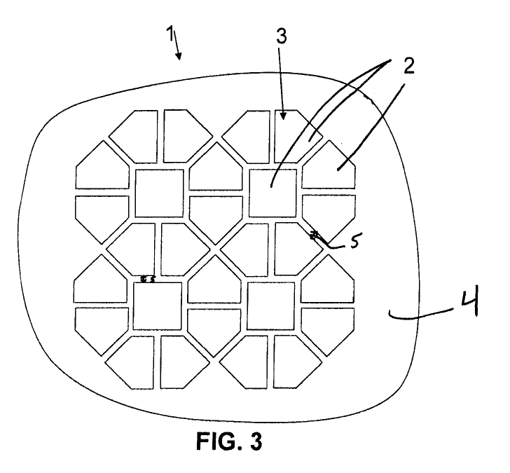

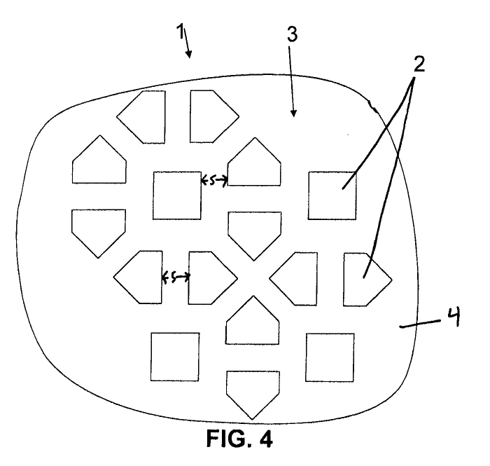

FIG. 1 shows a top plan view of a protective material 1 having a flexible substrate 3 and spaced-apart guard plates 2 according to one embodiment of the present invention. The guard plates 2 are affixed to a first or top surface 4 of the flexible substrate 3 in a spaced relationship to each other. In the embodiment illustrated in FIG. 1, the guard plates 2 have a hexagonal shape and are arranged in a regular and repeating pattern. In other embodiments, the guard plates 2 can have other shapes, e.g., circular, square, or any other polygon, and can be arranged in a random or irregular space-filling arrangement. In one embodiment, the guard plates 2 are arranged in a mathematical Penrose tile arrangement. The guard plates 2 have a gap width 5 between adjacent plates 2. In other embodiments, the assembly of guard plates 2 includes a variety of different shapes (as shown in FIGS. 3-4). In the embodiment illustrated in FIG. 1B, the vertical profile of the guard plates 2 has the form of a dome. In the embodiment illustrated in FIG. 1C, the vertical profile of the guard plates 2 is generally flat.

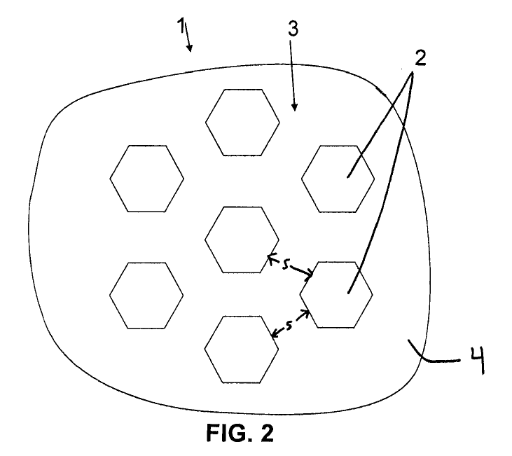

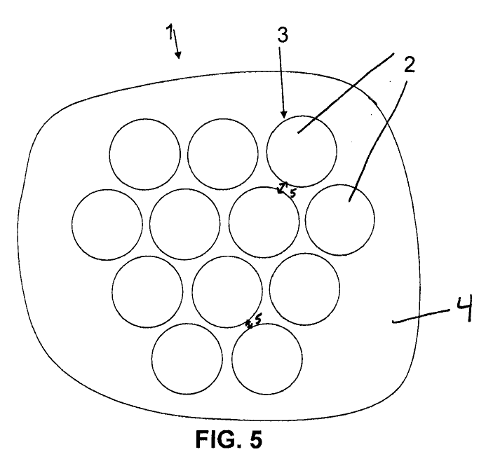

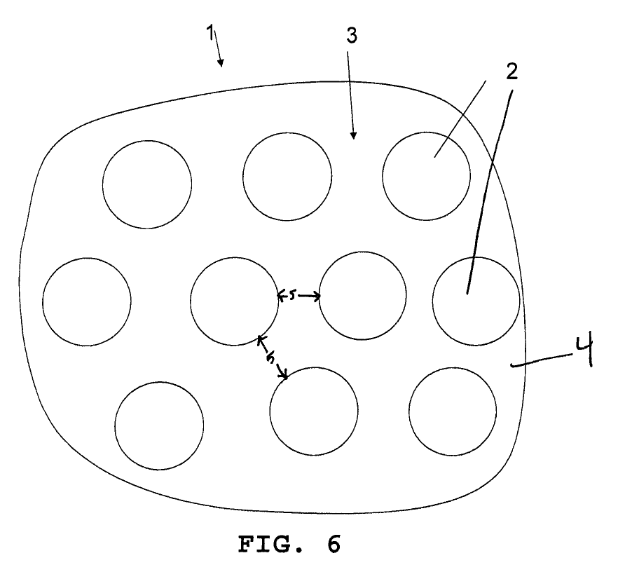

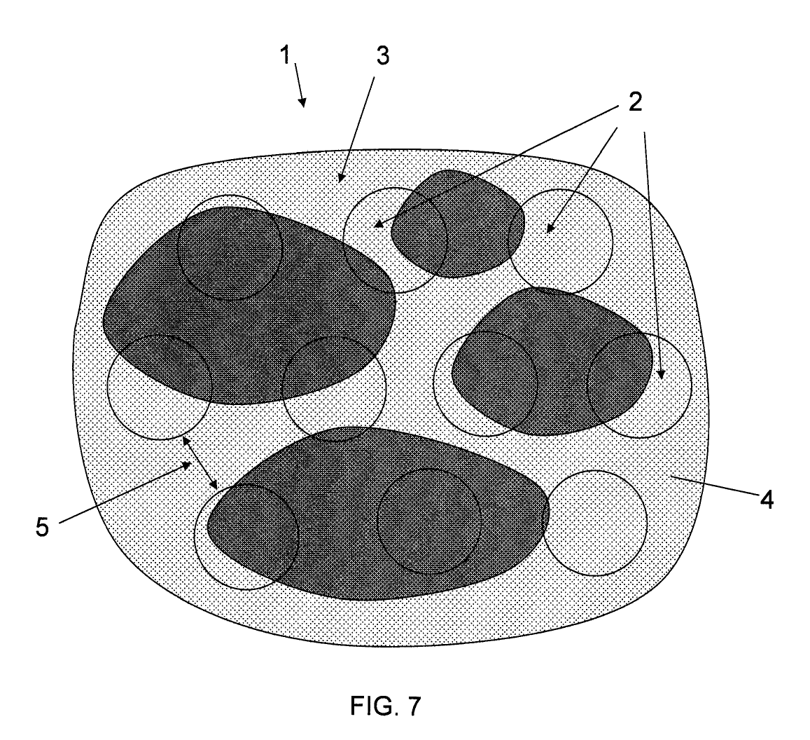

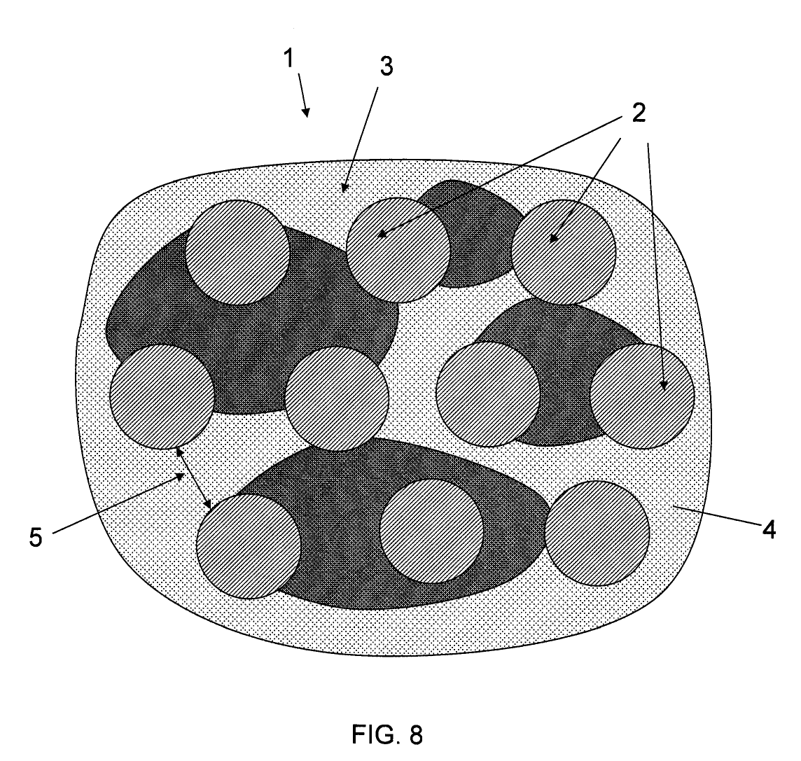

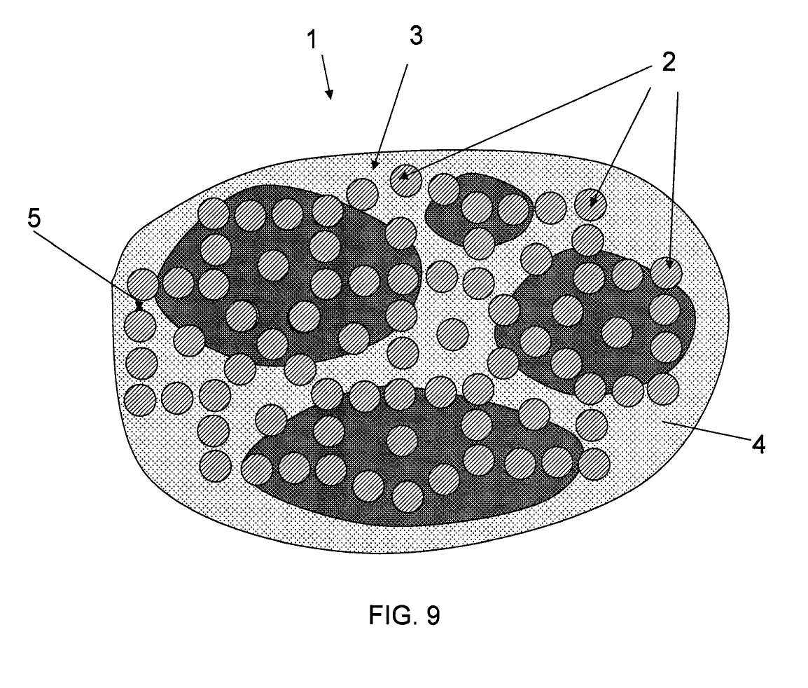

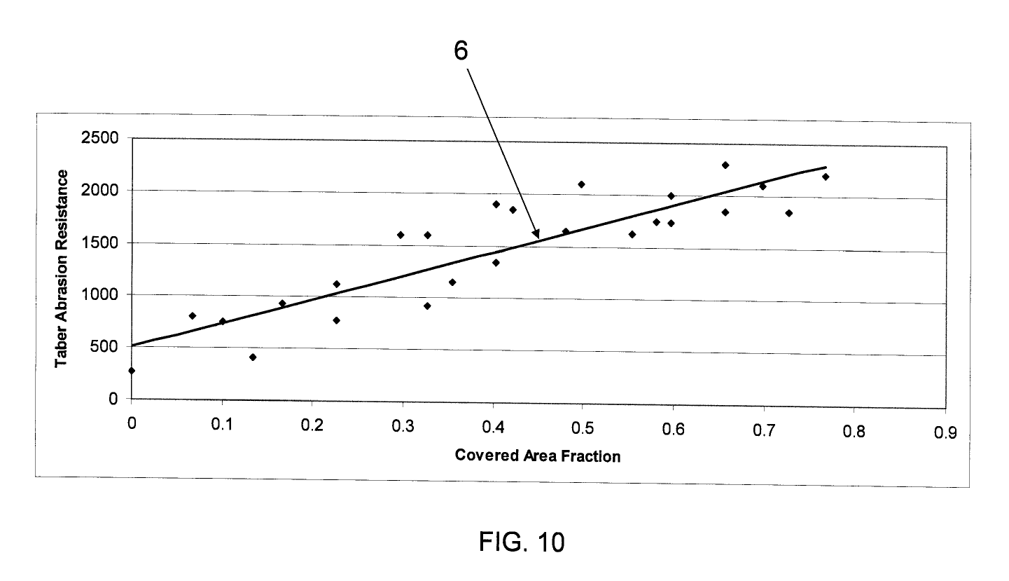

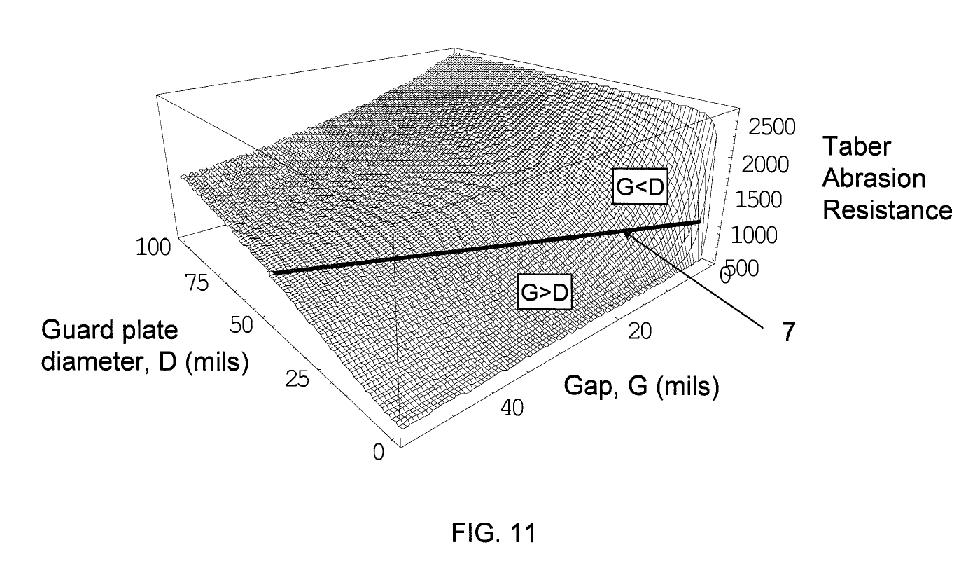

FIGS. 2-9 illustrate alternative embodiments of the protective material 1. FIG. 2 shows a top plan view of a protective material 1 having a flexible substrate 3 and spaced-apart hexagonal plates 2 according to another embodiment of the present invention. As shown in FIG. 2, the guard plates 2 have a larger gap width 5 than the plates shown in FIG. 1A. FIGS. 3 and 4 are top plan views of a protective material 1 having a flexible substrate 3 and spaced-apart pentagon and square plates 2 according to other embodiments of the present invention. FIGS. 5-6 are top plan views of a protective material 1 having a flexible substrate 3 and spaced-apart circular plates 2 according to other embodiments of the present invention. FIG. 7 is a top plan view of a protective material 1 having a flexible camouflage colored and patterned substrate 3 and transparent guard plates 2 according to an embodiment of the present invention. FIG. 8 is a top plan view of a protective material 1 having a flexible camouflage colored and patterned substrate 3 and colored guard plates 2 whose color is chosen to blend in with the colored substrate according to an embodiment of the present invention. FIG. 9 illustrates an alternative embodiment where adjacent plates 2 are closely spaced. This embodiment gives good abrasion resistance while allowing for more of the substrate to be open. FIGS. 10-11 show how the abrasion resistance of SuperFabric® brand material varies with covered area fraction, guard plate diameter, and gap.

The diameter of the guard plates 2 and the gap width 5 between the guard plates 2 can vary. In one embodiment, the diameter of the guard plates 2 is between about 40 and about 100 mils. In another embodiment, the gap width 5 is between about 5 and about 100 mils. In yet another embodiment, the diameter of the guard plates 2 is between about 80 and about 200 mils and the gap width 5 is between about 20 and about 200 mils. In one embodiment, the gap width 5 is generally the same or similar throughout the protective material 1. In another embodiment, the gap width 5 varies throughout the protective material 1. In one embodiment, the thickness or height of the plates 2 can be between about 2 and about 40 mils. In one embodiment, the diameter of the guard plates 2, gap width 5, and thickness of the plates 2 are selected to maintain clear visibility of the appearance and aesthetics of the top surface 4 and the flexible substrate 3.

The plates can be any shape, but convex shaped plates tend to provide advantages in overall flexibility and reduced propensity for plate cracking. The plates will have major and minor diameters. When hard guard plates are used, the ratio of major diameter to minor diameter should not be too large or the guard plates will have a propensity to crack. In one embodiment, the ratio of the major diameter to minor diameter is between about 1 and about 3. Also, if hard guard plates are used, the ratio of minor diameter to guard plate thickness should not be too large in order to prevent cracking. In one embodiment, the ratio of minor diameter to plate thickness is less than about 10.

In the embodiments shown in FIGS. 1A and 2-8, the gap widths 5 between adjacent, nearest-neighbor guard plates 2 is generally uniform. In preferred embodiments of the invention, the largest gap widths 5 between the adjacent, nearest-neighbor guard plates 2 is less than the lengths of the major or minor dimensions (e.g., less than about 200 mils).

Other embodiments of the invention such as that shown in FIG. 9 have greater variations in the gap width 5. In the embodiment shown in FIG. 9, most or a majority of the guard plates 2 have gap widths 5 between adjacent, nearest-neighbor guard plates that are less than the lengths of the major or minor dimensions (e.g., less than about 200 mils). Some of the guard plates 2 in the embodiment shown in FIG. 9 are isolated from other adjacent guard plates 2 and have nearest-neighbor guard plates spaced by gap widths 5 greater than the lengths of the major or minor dimensions of the guard plates. Although the embodiment of the invention shown in FIG. 9 has opaque guard plates 2, clear or translucent guard plates can also have spacing arrangements such as those described in connection with FIG. 9.

Various embodiments of the protective material 1 and methods of manufacturing the protective material 1 are described in commonly owned U.S. Pat. No. 6,962,739, entitled SUPPLE PENETRATION RESISTANT FABRIC AND METHOD OF MAKING, filed Jul. 6, 2000, U.S. Pat. No. 7,018,692, entitled PENETRATION RESISTANT FABRIC WITH MULTIPLE LAYER GUARD PLATE ASSEMBLIES AND METHOD OF MAKING THE SAME, filed Dec. 21, 2001, U.S. Patent Application Publication No. 20040192133, entitled ABRASION AND HEAT RESISTANT FABRICS, Ser. No. 10/734,686, filed on Dec. 12, 2003, U.S. Patent Application Publication No. 20050170221, entitled SUPPLE PENETRATION RESISTANT FABRIC AND METHOD OF MAKING, Ser. No. 10/980,881, filed Nov. 3, 2004, and U.S. Patent Application Publication No. 20050009429, entitled FLAME RETARDANT AND CUT RESISTANT FABRIC, Ser. No. 10/887,005, filed Nov. 3, 2004, all herein incorporated by reference in their entirety.

In one embodiment, the guard plate 2 is manufactured using a resin selected for its protective qualities, for example, cut, pierce, puncture resistance, durability, and other protective qualities, as well as its bonding characteristics to the flexible substrate 3. One suitable material for the guard plate 2 is a thermosetting epoxy resin. The gap width 5 is selected in order to maintain flexibility of the flexible substrate 3, which permits the overall protective material 1 to exhibit and preserve its properties of flexibility and suppleness. In one embodiment, the guard plates 2 are composed of a rigid and hard, or tough and non-brittle material. 2. In one embodiment, the guard plates 2 are made from a material having a hardness greater than or equal to 10 on the Shore D hardness scale. In another embodiment, a softer polymer with a Shore D hardness range of between 10 and 50, such as silicone rubber or plasticized polyvinyl chloride (PVC) is used as the guard plate 2 material to add grip characteristics to the guard plates 2 while still providing substantial abrasion resistance due to the elastic property of these materials, which causes the material to easily yield and deform under applied stress and thus make it more difficult for an abrading object to mechanically engage the material in order to abrade it. In another embodiment, a harder polymer with a Shore D hardness range of between 50 and 100 such as epoxy is used as the guard plate 2 material to provide substantial abrasion resistance or cut or puncture resistance in applications where grip characteristics in the guard plates 2 are not required. Using a harder plate also has an advantage for use in clothing that is to be worn in areas where sharp rocks could potentially cut into the fabric. Hard plates will provide more protection in this case compared to the protection provided by relatively soft plates. In one embodiment, plates with hardness greater than Shore D 100 are used. In another embodiment, hard plates (made from epoxy, for example) are used as one layer, and then softer plates (made from silicone, for example) are applied as a second layer. The layers generally do not need to be registered in any way. The relatively soft layer, in this case, can be dots or other patterns including a continuous phase of soft material. In one embodiment silicone dots are used with a diameter of 100-400 mils and with spacing of 20-400 mils.

The flexible substrate 3 is typically also chosen to fulfill desired performance characteristics. For instance, the flexible substrate 3 can comprise a single layer of fabric or include multiple layers with varying physical characteristics in which the layers are laminated or bonded to one another. Typical desired physical considerations for the flexible substrate 3 include tensile, burst and tear strength, flexibility/suppleness, water-proofness, air permeability, tactility and comfort. In certain applications, elasticity of the flexible substrate 3 is also desired. In one embodiment, the flexible substrate 3 is a polymer film laminated to a fabric where the fabric contains a colored pattern. In another embodiment, the flexible substrate 3 is a woven fabric. In another embodiment, the flexible substrate is a knitted fabric. In yet another embodiment, the flexible substrate 3 is a non-woven fabric. In one embodiment, the flexible substrate 3 has a pattern or image on the top surface 4. In one embodiment, the pattern or image is a camouflage pattern. In one embodiment, the pattern is printed on the top surface 4. In another embodiment, the pattern is woven into the flexible substrate 3.

In one embodiment such as that shown in FIG. 7, the clear visibility or viewability of the top surface 4 of the flexible substrate 3 is accomplished through the use of guard plates 2 having the physical property of being transparent, or translucent without appreciable scattering, to the visible light wavelength spectrum. The camouflage pattern on the substrate 3 is shown schematically with limited color and pattern variation in FIG. 7 (i.e., black and white). Other camouflage patterns having other patterns and more or less colors can also be used on the substrate 3. In still other embodiments (not shown) patterns other than camouflage patterns are on the substrate 3. For example, photographs, words, symbols, drawings and other indicia and images can be printed, woven or otherwise formed on or in the substrate 3.

In yet other embodiments such as that shown in FIGS. 8 and 9, the clear visibility or viewability of the top surface 4 of the flexible substrate 3 is accomplished through the use of opaque guard plates 2 having one or more colors chosen to blend in with the color of the substrate and sufficient gaps between plates that the color of the substrate shows through the gaps. In the example shown in FIG. 8, for instance, the color of the guard plates 2 can be the predominant color of a multiple-colored camouflage pattern. In other embodiments (not shown) different guard plates have different colors. In still other embodiments (not shown) the guard plates can be registered in location to the sections of the camouflage pattern, and have the same or similar colors as the section of the pattern behind the guard plates. In effect, the colors and/or the locations of the guard plates are selected to form part of and/or visually blend in with the pattern on the substrate so as to present a visually coherent pattern. Although this embodiment of the invention is described in connection with a camouflage pattern, other embodiments (not shown) include other patterns such as photographs, words, symbols, drawings and other visual indicia and images that are printed, woven or otherwise formed on or in the substrate 3. In one embodiment, the guard plates 2 are constructed from various types of transparent thermal or ultraviolet (UV) cured resins. The resin is selected based upon the demands of the particular application. In one embodiment, about 80% or more of the amplitude of light that impinges upon the surface of the guard plates 2 passes through the plates 2 with less than about 20% of the amplitude of the incoming light scattered diffusely. In another embodiment, the guard plates 2 have the ability to transmit light without appreciable scattering so that the portions of the flexible substrate 3 covered by the guard plates 2 are visible.

Transparent or translucent plates 2 allow the protective material 1 to be used in applications requiring slash and abrasion protection in a flexible substrate 3, yet simultaneously require clear visibility of the appearance and aesthetics of the flexible substrate 3 and its top surface 4. Under some circumstances, the flexible substrate 3 is protected from external mechanical wear to avoid sudden or gradual degradation of the color (or in essence the dye or pigment of the substrate), texture, and any weave or color patterns in the flexible substrate 3. The translucent or transparent guard plates 2 reduce or prevent mechanical wear on the flexible substrate 3, yet do not impede a clear view of the flexible substrate 3 itself and its top surface 4.

The guard plates 2 can be manufactured from glass, ceramic, UV curable, thermoplastic, or thermoset materials. In one embodiment, glass plates 2 are adhered to the flexible substrate 3 using a transparent glue. In another embodiment, UV curable and thermoset materials are formulated to be liquid or paste resins at room temperature before they are crosslinked upon heating or UV curing the material. These resins are printed onto the surface of the substrate and then subsequently crosslinked upon the addition of heat, UV radiation, or a combination of heat and UV radiation. Electron beam and other curing systems can also be used. In another embodiment, a thermoplastic material is heated to a liquid or paste state and then printed onto the top surface 4 of the flexible substrate 3 in a manner similar to that used to print UV curable or thermoset resins. As the resin cools, the thermoplastic material hardens and affixes to the flexible substrate 3. In other embodiments, the guard plates 2 are made from ceramic, metal, or a composite material. In one embodiment, the protective material 1 has a combination of guard plates 2 made from a variety of different materials. In one embodiment, the resin material of the guard plates is a diglycidyl ether of bisphenol-A with amine curing agents and glass beads

In one embodiment, the guard plates 2 are manufactured using a combination of curing and screen-printing processes. In one embodiment, the polymer resin used for each guard plate 2 is a one-part heat-curable epoxy resin. The polymeric resin exhibits viscoelastic and thixotropic fluid behavior suitable for screen-printing at room temperature. A screen is used to print the guard plates 2 on the flexible substrate 3. In one embodiment, the plates 2 are then partially cured in a thermal or UV oven to the point where the resin no longer flows as a fluid. In one embodiment, the plates 2 are cured between about 90° C. and about 150° C. for between about 20 and about 90 minutes. In one embodiment, the guard plates 2 receive a mechanical imprint while in a partially cured or partially solidified state, thereby imparting a desired texture to the surface of the guard plates 2.

The physical and mechanical properties of the guard plates 2 can be custom-engineered to meet specific performance requirements of a given application. In one embodiment, the formulation of the material comprising the guard plates 2 can be modified to give the cured resin varying degrees of gloss and luster. Many resins can be used that result in shiny guard plates 2. In one embodiment where a thermoset epoxy resin is used for the guard plate material, the reflectance of the guard plates 2 can be adjusted through selection of a curing agent. In one embodiment, the curing agent is an amine or a blend of amines. In one preferred embodiment for achieving plates with a matte finish, the thermoset epoxy resin includes a diglycidyl ether of bisphenol-A and a latent curing agent of about 50% dicyandiamide and about 50% aliphatic polyamine. In an embodiment that gives guard plates with a shinny finish, the thermoset epoxy resin includes a diglycidyl ether of bisphenol-A and an aliphatic amine curing agent. In other embodiments, matting agents are added to the resin to give the guard plates 2 a matte finish. In one embodiment, the matting agent is silica. In another embodiment, the matting agent is wax particles. In one embodiment, sufficient matting agent is added to result in a matte finish while the transparency or translucency of the guard plates 2 is maintained.

In an alternative embodiment, fillers are added to the guard plate material to strengthen the guard plates 2. In one embodiment, the transparency of the plates 2 is preserved by choosing a filler whose index of refraction is close to the index of refraction of the guard plate material. For example, diglycidyl ether of bishphenol-A has an index of refraction of about 1.57 and glass beads (type A glass) has an index of refraction of about 1.51-1.52. The difference in index of refraction is small enough that the resin remains reasonably transparent when about 10-50% by weight of glass bead is added. This ensures that light does not scatter significantly from the interface between the filler and the continuous phase of the resin or material used in the guard plates 2. In one embodiment, the gaps between the plates 2 are chosen to be small so that significant puncture resistance is obtained as well as slash and abrasion resistance. In another embodiment, multiple layers of guard plates attached to a fabric can be used to increase cut, slash, or abrasion resistance, yet the top surface 4 of the outermost flexible substrate 3 remains clearly visible.

In some instances, it can be difficult to achieve perfectly transparent guard plates 2. For example, if a high concentration of matting agent is used, the guard plates 2 can be cloudy. In other instances, the transparent resin will wick into the flexible substrate 3 and darken the color of the flexible substrate 3. Therefore, in some embodiments, the visibility of the flexible substrate 3 is maximized and any color shift caused by the resin is minimized by using a large gap width 5. In one embodiment, the guard plates 2 are about 40 to about 200 mils in diameter and have a gap width 5 of about 5 to about 200 mils. In another embodiment, guard plates 2 having a diameter of about 50 to about 100 mils and a gap width 5 of about 20 to about 100 mils are printed on a patterned flexible substrate 3, thereby allowing the pattern to be clearly seen while still providing excellent abrasion resistance.

The area fraction covered by guard plates is another parameter that can be considered. A higher covered area fraction gives better abrasion resistance, but in the case of colored or translucent guard plates, also gives a greater degree of interference with any colored pattern of the substrate.

FIGS. 10 and 11 show the abrasion resistance of a composite structure, which has guard plates made from an epoxy resin containing glass bead filler and pigments printed onto a 600 denier woven polyester fabric, measured with a Taber tester using H-19 wheels with 1000 gram weights. Although the resin used to collect this data was colored due to the addition of pigments, this does not significantly affect abrasion resistance and the main results apply equally well to transparent resins. FIG. 10 shows that the abrasion resistance as a function of plate diameter and gap varies approximately linearly with covered area fraction. They also show that having a covered area fraction as small as about 25% can approximately double the abrasion resistance of the base fabric. FIG. 11 uses the curve 6 fit to the data shown in FIG. 10 to show the abrasion resistance as a function of gap and plate diameter. The line 7 in FIG. 10 separates the region where the gap is greater than the plate diameter from the region where the gap is less than the plate diameter. From this figure it can be seen that the gap should be less than the plate diameter in order to obtain the best abrasion resistance.

In one embodiment, the covered area fraction is between about 10% and 90%. In other embodiments the covered area fraction is between about 25% and 50%.

In an alternative embodiment, the guard plates 2 are made from a flame retardant and/or a flame resistant material. In one embodiment, the guard plates 2 are made from a diglycidyl ether of bisphenol-A incorporating a flame-retardant powder additive, resulting in an acceptable level of flame retardance and/or flame resistance while maintaining a reasonable degree of transparency. In one embodiment the flame retardant additive is aluminum trihydrate, magnesium hydrate, ammonium polyphosphate, or a blend of these ingredients. In other embodiments, other transparent or translucent compounds which provide flame retardance and/or flame resistance (e.g., halogenated epoxy resins). In one embodiment, both the flexible substrate 3 and the guard plates 2 are made from a flame retardant and/or flame resistant material, resulting in a flame retardant and/or flame resistant protective material 1. In other embodiments, non-halogenated flame retardant additives can be incorporated into the formulation to provide a resin that preserves the high degree of transparency or translucency, while providing a much more environmentally-friendly and user-safe alternative to traditional halogenated flame retardant additives. In one embodiment, an epoxy resin comprised of oligomers containing both a phosphorous and oxirane group is utilized, such as bis-glycidyl phenyl phosphate, together with a curing agent such as bis(4-aminophenyl) phenyl phosphate. An alternative approach to phosphorous-containing epoxy resins is to include the phosphorous group within the curing agent molecule rather than the epoxy molecule of the resin. Examples of this type of curing agent include bis(m-aminophenyl) methylphosphine oxide (BAMPO), di- and tri-amino cyclotriphosphazenes, and di- and tri-hydroxy cyclotriphosphazenes and various phosphine oxides.

In other embodiments, the guard plates 2 are opaque rather than transparent or translucent. The opaqueness can result from the addition of a flame retardant agent or from the choice of filler or resin. In these embodiments, clear visibility of the top surface 4 of the flexible substrate 3 is achieved through the use of a relatively large gap width 5 between the guard plates 2. The large gap width 5 allows the color of and any pattern printed on the top surface 4 or woven into the flexible substrate 3 to be clearly visible despite the guard plates 2. In one embodiment, the guard plates 2 are printed on a flexible substrate 3 having a camouflage pattern, are about 70 to about 80 mils in diameter, and have a gap width 5 of about 40 to about 50 mils. In one embodiment, a pigment is added to the resin, resulting in guard plates 2 having a color that is similar to a dominant color of the flexible substrate 3. Use of the pigment in the guard plates 2 allows the color of and any pattern printed on or woven into the flexible substrate 3 to be clearly visible despite the guard plates due to a number of contextual cues the brain receives from the adjacent foreground and background colors in a visual effect known as color constancy, and how the human eye and brain perceives color overall. The net result is for the color of the foreground guard plates 2 to blend in with the multi-colored pattern of the background substrate, creating an illusion to the human eye that the entire substrate is clearly visible and recognizable, even in cases where a substantial percentage of the substrate area is covered by the guard plates 2. As discussed above, as little as 25% covered area fraction is needed to substantially improve abrasion resistance. With this coverage fraction, colored patterns on the flexible substrate show through the pattern of guard plates very clearly when the color of the guard plates is chosen to blend in with the colored pattern of the substrate. A unique feature of the present invention is choosing the color of the guard plates so that a relatively high covered area fraction, for example about 25-50%, will still allow a high level of visibility of the underlying colored pattern. Using higher levels of guard plate coverage in this way allows for a surprisingly high level of the colored pattern of the flexible substrate to show through the pattern of guard plates.

In one embodiment, the top surface 4 of the flexible substrate 3 contains a camouflage pattern and the guard plates 2 have a color that is chosen to blend in with the camouflage pattern. In this embodiment the camouflage pattern is readily visible. In other embodiments, clear guard plates are used on a camouflage substrate.

In one embodiment, additives can be added to the material used to construct the guard plates 2 in order to shift the infrared signature of the material. Such infrared additives are available from Epolin, Inc. 358-364 Adams Street, Newark, N.J. 07105. This has applications for military clothing where the infrared signature of the clothing is required to be within ranges specified by the military. In one embodiment, a combination of iron oxide and titanium dioxide pigments in an amber-tinted epoxy resin provides for a good color for blending into the background of a camouflage pattern while satisfying the military's requirements of infrared signature.

In an alternative embodiment, the guard plates 2 include a phosphorescent or other type of self-luminescing (i.e. glow-in-the-dark) additive. Use of a phosphorescent additive allows the guard plates 2 to phosphoresce when placed in a dimly lit environment after the guard plates 2 are exposed to a light source for at least several hours. This characteristic can be very useful for applications where a slash/abrasion resistant garment that is also clearly visible in dark surroundings is preferred (e.g., a worker performing road construction during night or evening hours). Phosphorescent and other glow-in-the-dark powders can be obtained from MPK CO. 602 West Clayton Avenue, Clayton, Wis. 54004-9101, for example.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What is claimed is:

1. A supple, globally flexible composite structure, comprising:
a flexible substrate having a surface with a colored pattern including two or more colors; and
an array of small, non-overlapping, printed resin material guard plates having major and minor dimensions arranged in a predetermined pattern over a substantial portion of the surface of the substrate, wherein the guard plates are transparent or translucent to visible light so that the colored pattern on the surface of the substrate is visible.

2. The composite structure of claim 1 wherein at least most of the guard plates have gap widths between nearest-neighbor guard plates that are less than about the lengths of the major dimensions of the guard plates.

3. The composite structure of claim 2 wherein gap widths between adjacent guard plates is generally uniform.

4. The composite structure of claim 2 wherein the minor dimensions of the guard plates are less than about 200 mils.

5. The composite structure of claim 1 wherein gap widths between adjacent guard plates is generally uniform.

6. The composite structure of claim 5 wherein the minor dimensions of the guard plates are less than about 200 mils.

7. The composite structure of claim 1 wherein the guard plates have a minimum hardness of about Shore D 10.

8. The composite structure of claim 1 and further including a clear polymer film between the flexible substrate and the guard plates.

9. The composite structure of claim 1 wherein the resin material of the guard plates includes polymer having an index of refraction and a filler material having an index of refraction that is close to the index of refraction of the polymer.

10. The composite structure of claim 1 wherein the guard plates have a matte finish.

11. The composite structure of claim 1 wherein the guard plates are flame retardant.

12. The composite structure of claim 1 wherein the guard plates are self-luminescing.

13. The composite structure of claim 1 wherein the guard plates cover between about 25% and about 50% of the substrate.

14. The composite structure of claim 1 wherein the colored pattern is a camouflage pattern.

15. The composite structure of claim 1 wherein gap widths between nearest-neighbor guard plates are between about 30 mils and 60 mils, the minor dimensions of the guard plates are between about 60 mils and 100 mils, a thickness of the guard plates is between about 5 mils and 30 mils, and the guard plates have a hardness greater than about Shore D 50.

16. The composite structure of claim 15 wherein the colored pattern is a camouflage pattern.

17. The composite structure of claim 16 wherein gap widths between adjacent guard plates is generally uniform.

18. A supple, globally flexible composite structure, comprising:
a flexible substrate having a surface with a colored pattern including two or more colors; and
an array of small, non-overlapping, printed resin material guard plates including two or more colors and having major and minor dimensions arranged in a predetermined pattern over a substantial portion of the surface of the substrate, wherein the colors of the guard plates blend in with the colored pattern of the substrate.

19. The composite structure of claim 18 wherein at least most of the guard plates have gap widths between nearest-neighbor guard plates that are less than about the lengths of the major dimensions of the guard plates.

20. The composite structure of claim 19 wherein gap widths between adjacent guard plates is generally uniform.

21. The composite structure of claim 20 wherein the minor dimensions of the guard plates are less than about 200 mils.

22. The composite structure of claim 18 wherein gap widths between adjacent guard plates is generally uniform.

23. The composite structure of claim 22 wherein the minor dimensions of the guard plates are less than about 200 mils.

24. The composite structure of claim 18 wherein the guard plates have a major dimension to minor dimension aspect ratio between about 3 and 1.

25. The composite structure of claim 18 wherein the guard plates have a minimum hardness of about Shore D 10.

26. The composite structure of claim 18 and further including a clear polymer film between the flexible substrate and the guard plates.

27. The composite structure of claim 18 wherein the guard plates have a matte finish.

28. The composite structure of claim 18 wherein the guard plates are flame retardant.

29. The composite structure of claim 18 wherein the guard plates cover between about 25% and about 50% of the substrate.

30. The composite structure of claim 18 wherein the colored pattern is a camouflage pattern.

31. The composite structure of claim 18 wherein gap widths between nearest-neighbor guard plates are between about 30 mils and 60 mils, the minor dimensions of the guard plates are between about 60 mils and 100 mils, a thickness of the guard plates is between about 5 mils and 30 mils, and the guard plates have a hardness greater than about Shore D 50.

32. The composite structure of claim 31 wherein the colored pattern is a camouflage pattern.

33. The composite structure of claim 32 wherein gap widths between adjacent guard plates are generally uniform.

34. The composite fabric of claim 18 wherein the guard plates include infrared signature-enhancing material.
